(19) United States
(12) Patent Application Publication
(10) Pub. No.: US 2010/0006391 A1
(43) Pub. Date: Jan. 14, 2010

(54) COIN LOCK

(75) Inventor: Ake Haggstrom, Lycksele (SE)

Correspondence Address: HOLLAND & HART, LLP, P.O BOX 8749, DENVER, CO, 80201, US

(73) Assignee: ASSA AB, Eskilstuna (SE)

(21) Appl. No.: 12/492,988

(22) Filed: Jun. 26, 2009

(30) Foreign Application Priority Data
Jul. 11, 2008 (SE) 0801670-1

(51) Int. Cl. G07F 5/02

(52) U.S. Cl. 194/247

(57) ABSTRACT

Coin lock comprising a lock housing, a coin opening part (1) with a coin opening having an oblong cross section perpendicular to the direction of inserting the coin, for introducing a coin into the lock housing, and a coin limiting arrangement which is designed to prevent a coin with a diameter bigger than a defined maximum diameter from being introduced into the lock housing through the coin opening. The coin limiting arrangement comprises a blocking element (5, 50, 51) which can be inserted from the outside into the coin opening and which comprises first engaging units which are designed, in engagement with second engaging units arranged at the coin opening part, to enable a detachable fixation of the blocking element in the coin opening at various positions along the lengthways direction of the coin opening's cross section.

### BACKGROUND AND FIELD OF THE INVENTION

The invention relates to a coin lock and more specifically to a coin lock of the kind indicated in the preamble of claim 1.

Such coin locks can be used, for example, in cabinets and storage boxes at public places such as sports halls, public swimming baths, train stations, airports and the like.

The coin locks can operate on the pawn principle, when the coin inserted is returned after use, or on the pay principle, when the coin is not returned.

For such coin locks it may be desirable to limit the size of the coin opening so that only coins of a certain maximum diameter can be introduced into the lock housing.

### PRIOR ART

EP 0 945 836 A describes a coin lock which can be manoeuvred after a coin has been inserted through a coin opening in the lock. The coin lock can be provided with a coin limiting arrangement which is attached directly in front of the coin opening during assembly of the coin lock. The coin limiting arrangement comprises permanently attached elements which prevent a coin with a diameter bigger than a certain predetermined maximum diameter from being introduced into the coin lock through the coin opening. The predetermined maximum permissible diameter is defined by the distance between the permanently attached elements. With such an arrangement, it is therefore necessary to make different coin limiting arrangements for each maximum permissible coin diameter able to be introduced into the lock. Furthermore, it is not possible to alter the maximum permissible coin diameter of an existing lock, unless the lock is opened, the previous coin limiting arrangement is removed, a new coin limiting arrangement is put in place and the coin lock is reassembled. Thus, this arrangement has serious drawbacks both in terms of manufacturing, warehousing and cost standpoints and in terms of use of the coin lock.

### BRIEF ACCOUNT OF THE INVENTION

One object of the invention is therefore to provide an improved coin lock with which it is possible to prevent a coin with a diameter bigger than a defined maximum permissible diameter to be introduced into the coin lock through the coin opening.

Another aim is to provide such a coin lock in which the maximum permissible coin diameter can be easily varied.

A further aim is to provide such a coin lock with which the maximum permissible coin diameter can be varied by using one and the same element.

Yet another aim is to provide such a coin lock with which the maximum permissible coin diameter can be varied without needing to open the coin lock.

A further aim is to provide such a coin lock with which the maximum permissible coin diameter can be defined precisely.

These and other objects are achieved with a coin lock of the kind indicated in the preamble of claim 1 and having the features indicated in the characterizing part.

The coin lock according to the invention comprises a lock housing, a coin opening part with a coin opening having an oblong cross section perpendicular to the direction of inserting the coin for introducing a coin into the lock housing, and a coin limiting arrangement which is designed to prevent a coin with a diameter bigger than a defined maximum diameter from being introduced into the lock housing through the coin opening. According to the invention, the coin limiting arrangement comprises a blocking element which can be inserted from the outside into the coin opening and which comprises first engaging units which are designed, in engagement with second engaging units arranged at the coin opening part, to enable a detachable fixation of the blocking element in the coin opening at various positions along the lengthways direction of the coin opening's cross section.

In this way, an easy readjustment of the maximum permissible coin diameter is made possible by making use of one and the same blocking element, which blocking element, upon change of the maximum permissible diameter, is quite simply moved to a different position in the coin opening. Since the blocking element can be introduced from the outside into the coin opening, it is not necessary to open the coin lock for readjustment of the maximum permissible coin diameter.

The coin lock expediently comprises a coin channel which defines the coin opening and which extends in a coin inserting direction, as well as a blocking element channel, arranged in the coin opening part and extending essentially perpendicular to the coin channel and intersecting it, wherein the blocking element can be introduced into the blocking element channel in a blocking element inserting direction which is parallel to the blocking element channel, such that the blocking element in the inserted position intersects the coin opening channel. Since the blocking element channel is arranged essentially perpendicular to the coin channel, it is possible to arrange the mouth of the blocking element channel such that it is covered by the door or similar element on which the coin lock is mounted. This prevents the blocking element from being moved out of the coin lock by mistake or by an unauthorized person when it is mounted on a door or similar element.

The first and second engaging units expediently comprise a number of interacting oblong sawtooth-shaped projections that extend essentially parallel to the direction of insertion of the blocking element in the blocking element channel. This provides a good fixation of the blocking element parallel to the lengthways direction of the coin opening's cross section. This prevents the blocking element from being moved crossways to the coin inserting direction, for example when an attempt is made to press in a coin with a diameter bigger than the defined maximum permissible diameter. The parallelism of the oblong projections to the direction of insertion of the blocking element at the same time allows the blocking element to be easily moved in and out of the blocking element channel.

The sawtooth projections making up the second engaging units are expediently arranged with a defined pitch on two opposite boundary walls of the blocking element channel, which boundary walls are parallel to the direction of insertion of the blocking element. This provides an embodiment which is relatively easy and cheap to manufacture.

The sawtooth projections making up the first engaging units are expediently arranged on two opposite and mutually parallel sides of the blocking element, with the same pitch as the projections on the boundary walls of the blocking element channel. By choice of a suitable common pitch for the projections in the blocking element channel and on the blocking element, it is thereby possible to obtain a desirable precision of adjustment for the maximum permissible coin diameter.

The projections on one of said opposite boundary walls of the blocking element channel are expediently displaced or shifted one half pitch length in relation to the projections on the other of said boundary walls, and the projections on one of said sides of the blocking element are expediently displaced or shifted one half pitch length in relation to the projections on the other of said sides of the blocking element. By turning the blocking device, it is possible to increase the precision of adjustment for the maximum permissible coin diameter to half the pitch length.

To facilitate handling when adjusting the maximum permissible coin diameter with a precision and in a manner that requires turning of the blocking arrangement, the latter expediently has, on one side, a marking that is visible from outside the coin lock when the blocking element is detachably secured in the coin opening.

The coin opening part is expediently arranged on a module unit which can be mounted on a lock housing. This produces a flexible design for coin locks that will be used for different applications. Moreover, this embodiment enables retrofitting of the coin opening part on existing coin locks, such that these can be provided with the advantageous coin limiting function according to the invention.

### BRIEF DESCRIPTION OF THE FIGURES

Illustrative embodiments of the invention are described below with reference to the figures, in which:

FIG. 1 is a schematic plan view from the side of a coin opening part configured as a module unit for a coin lock according to one embodiment of the invention.

FIG. 2 is a schematic plan view from above of the coin opening part shown in FIG. 1.

FIG. 3a-c are schematic plan views from three different sides of a blocking element which is part of the embodiment of the invention shown in FIGS. 1 and 2.

FIG. 4 is a schematic plan view from above of a coin lock according to another embodiment of the invention.

### DETAILED DESCRIPTION OF ILLUSTRATIVE EMBODIMENTS

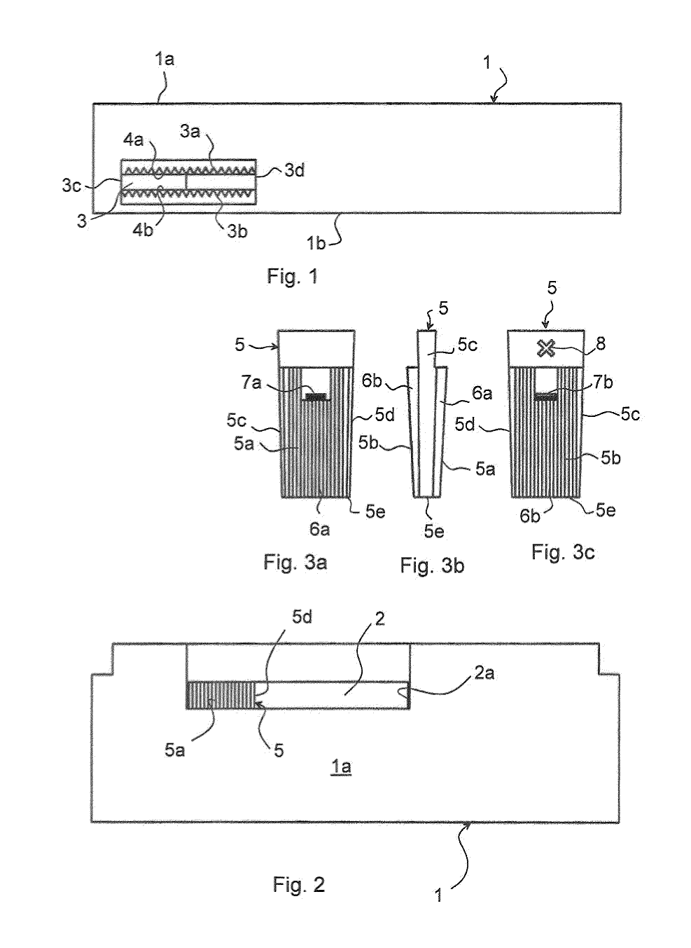

FIGS. 1 and 2 show a coin opening part configured as a module unit for a coin lock according to a first embodiment of the invention. The coin opening part 1 can be easily attached to different lock housings for coin locks to be provided with a coin limiting arrangement. The coin opening part 1 has, on its top side 1a, the mouth of a coin opening. The coin opening is defined by a coin channel 2 which extends perpendicularly downward from the top side 1a of the opening part 1 and through the coin opening part 1 to its bottom side 1b. The coin opening channel 2 and thus the coin opening have an oblong rectangular cross section. The length of the cross section is equal to or slightly larger than the diameter of the largest coin that can be introduced into the coin lock through the coin channel 2. The width of the cross section is sufficiently large to allow insertion of the thickest coin that can be introduced through the coin channel. In use, the coin opening part is secured to a lock housing of the coin lock and arranged such that the mouth of the coin channel 2 at the bottom side 1b of the coin opening part is placed at a corresponding coin entrance of the lock housing.

The coin opening part 1 furthermore has a blocking element channel 3. The blocking element channel 3 extends a distance into the coin opening part 1, from one side 1c of the coin opening part that is perpendicular to the top side 1a of the coin opening part. The blocking element channel 3 extends essentially perpendicular to the coin channel 2 and intersects this inside the coin opening part 1. The blocking element channel 3 has a rectangular cross section and is bounded at the top and bottom by two opposite boundary walls 3a, 3b. The blocking element channel 3 is bounded sideways by two opposite side boundary walls 3c, 3d.

The blocking element channel 3 is displaced sideways in relation to the coin channel 2. The blocking element channel's side boundary wall 3d, on the right in the figures, is arranged at a distance from the short right-hand side 2a of the coin channel's 2 cross section, which distance essentially corresponds to the minimum coin diameter for which the coin lock will be able to prevent insertion of coins with larger diameter.

Engaging units in the form of a number of oblong sawtooth-shaped projections 4a, 4b are arranged on the two boundary walls 3a and 3b. The projections 4a, 4b are arranged alongside each other and extend parallel to each other and to the lengthways direction of the blocking element channel 3. The projections 4a, 4b are also arranged with a certain constant and equal pitch. The projections 4a on boundary wall 3a are displaced or shifted half the pitch length sideways in relation to the projections 4b on boundary wall 3. In this way, the boundary walls 3a, 3b form respective rack segments.

FIGS. 3a-c show a blocking element 5 which can be secured releasably in the blocking element channel 3 and in the coin channel 2, at the intersection between the blocking element channel and the coin channel. The blocking element 5 has two opposite broad sides 5a, 5b and two opposite narrow sides 5c, 5d. The two broad sides 5a, 5b are arranged such that the distance between them decreases somewhat in the direction of one short side 5e of the blocking element, such that the blocking element narrows slightly in the direction of the short side 5e. The width of the blocking element 5, i.e. the distance between the two narrow sides 5c, 5d, is considerably less than the width of the blocking element channel 3. In this way, it is possible to introduce the blocking element 5 in different sideways positions in the blocking element channel 3.

Engaging units in the form of a number of oblong sawtooth-shaped projections 6a, 6b are arranged on the two broad sides 5a, 5b. The projections 6a, 6b are arranged alongside each other, extending parallel to each other and to the lengthways direction of the blocking element 5. Furthermore, the projections 6a, 6b are arranged with the same pitch as the projections 4a, 4b on the coin channel's boundary walls 3a, 3b. The projections 6a on the broad side 5a are displaced or shifted half the pitch length sideways in relation to the projections 6b on the broad side 5b.

The blocking element 5 furthermore has projecting fixation units 7a, 7b on both its broad sides 5a, 5b, and a visual marking 8 on one broad side 5b.

When the coin opening is to be bounded in order to prevent insertion of coins with a diameter larger than a certain defined maximum permissible diameter, the blocking element 5 is pushed into the blocking element channel 3 so far that the short side 5e passes the coin channel 2. This insertion of the blocking element 5 is facilitated by the slightly narrowing form of the blocking element 5. The blocking element 5 is introduced into the blocking element channel 3 in a chosen sideways position relative to the blocking element channel, such that the distance between the short side 2a of the coin channel's 2 cross section and the narrow side 5d of the blocking element arranged nearest this short side in the figures corresponds to the largest permissible coin diameter that can be introduced into the coin lock. By inserting the blocking element 5, without turning it, at various adjacent sideways positions defined by the interacting projections 4a, 4b, 6a, 6b, it is possible to place the narrow side 5d at a distance from the short side 2a of the coin channel's 2 cross section with an accuracy corresponding to one pitch length. By turning the blocking element about its lengthways axis between repeated insertions thereof, it is possible to increase this accuracy to half a pitch length.

When the blocking element 5 has been positioned in the blocking element channel 3 so that the coin opening has been limited to a suitable length, the coin lock is mounted with the coin opening part on the inside of a door or similar element. This mounting is done so that the opening of the blocking element channel is directed toward the door and is thus blocked by the latter. This prevents the blocking element from being moved out from the blocking element channel 3 by mistake or by an unauthorized person.

When the coin opening part, for example during transport, is not mounted on a door or the like, the blocking element is prevented from sliding out from the blocking element channel by means of the projecting fixation units 7a, 7b engaging with corresponding fixation units (not shown), such as snap units arranged in the coin opening part 1. The blocking element secured for transport in this releasable way can be pulled out from the blocking element channel by means of pliers or some other tool to enable readjustment of the maximum permissible coin diameter on site. According to one embodiment not shown, a recess such as a continuous hole can also be arranged in proximity to the end of the blocking element 5 opposite the narrowing end 5e. Such a recess facilitates pulling out the blocking element by using a nail or a pointed object, for example.

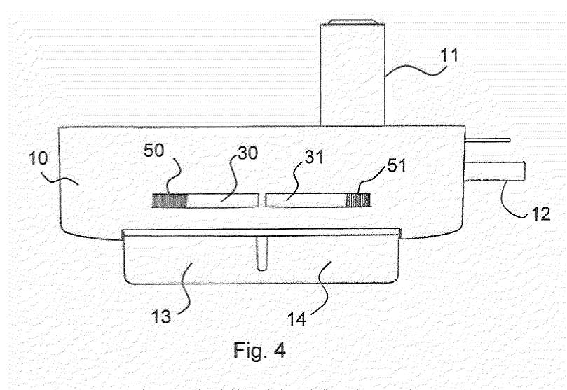

FIG. 4 shows a coin lock according to another embodiment. This coin lock comprises a coin opening part 10 which is arranged at a lock housing. A lock cylinder for operation by means of a key (not shown) is arranged at the lock housing. The coin lock also comprises a bolt 12 which projects out from the lock housing and can engage with a striking plate or the like. Two coin return compartments 13, 14 are arranged at the lower part of the coin lock.

The coin lock shown in FIG. 4 is designed to allow operation of the lock only after two coins have been inserted into the lock housing. For this purpose, the coin opening part 10 has two coin openings 30, 31 and two corresponding blocking element channels (not shown). A blocking element 50, 51 can be introduced into each of these blocking element channels to limit the coin openings in corresponding manner as described above.

Illustrative embodiments of the invention have been described above. However, it will be appreciated that the invention is not limited to these embodiments and instead can be freely varied within the scope of the attached claims. For example, instead of the coin opening part being designed as a separate module unit which can be attached to a lock housing, it can be an integrated part of the lock housing. Moreover, if so desired, the coin channel and the blocking element channel can be one and the same channel, in which case the direction of insertion of the blocking element coincides with the coin insertion direction.

1. Coin lock comprising a lock housing, a coin opening part (1) with a coin opening having an oblong cross section perpendicular to the direction of inserting the coin, for introducing a coin into the lock housing, and a coin limiting arrangement which is designed to prevent a coin with a diameter larger than a defined maximum diameter from being introduced into the lock housing through the coin opening, characterized in that the coin limiting arrangement comprises a blocking clement (5, 50, 51) which can be inserted from the outside into the coin opening and which comprises first engaging units which are designed, in engagement with second engaging units arranged at the coin opening part, to enable a detachable fixation of the blocking element in the coin opening at various positions along the lengthways direction of the coin opening's cross section.

2. Coin lock according to claim 1, comprising a coin channel (2) which defines the coin opening and which extends in a coin inserting direction, as well as a blocking element channel (3), arranged in the coin opening part (1) and extending essentially perpendicular to the coin channel and intersecting it, wherein the blocking element (5, 50, 51) can be introduced into the blocking element channel in a blocking element inserting direction which is parallel to the blocking element channel, such that the blocking element in the inserted position intersects the coin opening channel.

3. Coin lock according to claim 2, wherein the first and second engaging units comprise a number of interacting oblong sawtooth-shaped projections (4a, 4b, 6a, 6b) that extend essentially parallel to the direction of insertion of the blocking element.

4. Coin lock according to claim 3, wherein the sawtooth projections (4a, 4b) making up the second engaging units are arranged with a defined pitch on two opposite boundary walls (3a, 3b) of the blocking element channel (3), which boundary walls are parallel to the direction of insertion of the blocking element.

5. Coin lock according to claim 4, wherein the sawtooth projections (6a, 6b) making up the first engaging units are arranged on two opposite and mutually parallel sides (5a, 5b) of the blocking element (5), with the same pitch as the projections (4a, 4b) on the boundary walls (3a, 3b) of the blocking element channel (3).

6. Coin lock according to claim 5, wherein the projections (4a) on one (3a) of said opposite boundary walls of the blocking element channel (3) are shifted one half pitch length in relation to the projections (4b) on the other (3b) of said boundary walls, and the projections (6a) on one (5a) of said sides of the blocking element (5) are shifted one half pitch length in relation to the projections (6b) on the other (5b) of said sides of the blocking element.

7. Coin lock according to claim 1, wherein the blocking element (5) has, on one side, a marking (8) that is visible from outside the coin lock when the blocking element is detachably secured in the coin opening.

8. Coin lock according to claim 1, wherein the coin opening part (1) is arranged on a module unit which can be mounted on a lock housing.
